(19) United States
(12) Patent Application Publication
(10) Pub. No.: US 2021/0302954 A1
(43) Pub. Date: Sep. 30, 2021

(54) SYSTEM AND METHOD FOR INCREASING MEAN TIME BETWEEN SERVICE VISITS IN AN INDUSTRIAL SYSTEM

(71) Applicant: Siemens Aktiengesellschaft, Munich (DE)

(72) Inventors: Alexis Motto, Princeton, NJ (US); Amit Chakraborty, East Windsor, NJ (US)

(21) Appl. No.: 17/269,764

(22) PCT Filed: Aug. 31, 2018
(86) PCT No.: PCT/US2018/049106

§ 371 Date: Feb. 19, 2021

(51) Int. Cl. G05B 23/02; G06Q 10/00

(52) U.S. Cl. CPC G05B 23/0283; G06Q 10/20

(57) ABSTRACT

A method for increasing a meantime between service visits in an industrial system includes receiving event information from at least one information source, building an event network from the received event information, identifying a sequence of events indicative of a fault, and determining a cost-minimizing resolution to address the fault, wherein the event network is configured to identify a sequence of events that do not occur in direct chronological sequence. A services diagnostic engine may be configured to receive the event information, extract features of each event in the event information, identify a relationship between a first event and a second event and create a logical connection between the first and second event. The cost minimizing recommendation includes a remote operation to reset a component, for example remotely resetting a circuit breaker. The cost minimizing recommendation may be carried out automatically or presented to a user for consideration.

### TECHNICAL FIELD

This application relates to industrial systems. More particularly, this application relates to efficient servicing of industrial systems.

### BACKGROUND

Industrial systems often utilize a variety of components that may include computer-controlled machinery. This machinery may occasionally require maintenance or service. For example, a machine may begin operating abnormally resulting in a service call being placed to service personnel. Service personnel are dispatched to the location of the machine to diagnose and troubleshoot the problem.

### SUMMARY

According to embodiments of this disclosure a method for increasing a mean time between service visits in an industrial system includes receiving event information from at least one information source in communication with the industrial system, building an event network from the received event information, identifying a sequence of events indicative of a fault of the industrial system, and determining a cost-minimized resolution to address the fault of the industrial system, wherein the event network is configured to identify a sequence of events that do not occur in direct chronological sequence. According to some embodiments, a services diagnostic engine may be further configured to receive the event information, extract features of each event in the event information, identify a relationship between a first event and a second event and create a logical connection between the first event and the second event. The services diagnostics engine may also generate at least one internal report based on the received event information. Internal reports may include at least one of: a number of man hours required to perform a service embodied in the event information; a number of service technicians required to perform a service embodied in the event information; a number of components consumed in a service embodied in the event information; and/or a key performance indicator relating to a service embodied in the event information. External reports may also be generated by the services diagnostics engine based on the received event information. The external report may include documentation of the logical connection between the first event and the second event. According to embodiments, a services prescriptive analytics engine may be configured to analyze an unidentified events sequence from the event network and associate the unidentified events sequence with a fault associated with a component of the industrial system. A cost minimizing recommendation based on the fault associated with the unidentified events sequence may be created. Additionally, the services prescriptive analytics engine may annotate the unidentified events sequence with the fault associated with the unidentified events sequence. According to embodiments, the cost minimizing recommendation includes a remote operation to reset a component of the industrial system, for example the remote operation may include remotely resetting a circuit breaker. The cost minimizing recommendation may be carried out automatically. In other embodiments, the cost minimizing recommendation is presented to a user for consideration. The event information may be selected from at least one of the following information sources: a supervisory and data acquisition (SCADA) system; a monitoring, operating and registration system (MORS); a service tool for analysis and reimbursement (STAR); systems, applications and products (SAP); and weather data.

According to a system for increasing a mean time between service visits in an industrial system, a service diagnostics analytics engine is configured to receive event information from at least one information source in communication with the industrial system and produce an events network identifying event sequences associated with a fault of the industrial system and a service prescriptive analytics engine is configured to receive an events network from the service diagnostics analytics engine and perform a cost minimizing function to produce a cost minimizing recommendation to service a fault of the industrial system.

The system may further include a communication channel in communication with a remote component of the industrial system and the service prescriptive analytics engine, the communication channel configured to transmit a signal operative to execute a remote reset of the remote component based on the cost minimizing recommendation of the service prescriptive analytics engine and a user interface in communication with the service prescriptive analytics engine configured to present the cost minimizing recommendation to a user. In some embodiments, a remote controller is included for automatically performing an action based on the cost minimizing recommendation. The user interface may also include a first control that allows a user to select automatic execution of the cost minimizing recommendation and a second control that allows the user to schedule an in-person service visit, wherein one of the first control or the second control is selected based on the cost minimizing recommendation. The second control allows the user to select an action that is different than the cost minimizing recommendation.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a schematic diagram of an architecture for analyzing service needs of an industrial system according to aspects of embodiments described in this disclosure.

FIG. 2 is a functional block diagram of system or method for analyzing service needs of an industrial system according to aspects of embodiments described in this disclosure.

FIG. 3A is a timeline diagram of events in an industrial system according to aspects of embodiments described in this disclosure.

FIG. 3B is a timeline diagram of an events network based on the timeline of events of FIG. 3A in an industrial system according to aspects of embodiments described in this disclosure.

FIG. 4 is a block diagram of a computer system that may be used to implement systems of methods for analyzing service needs of an industrial system according to aspects of embodiments described in this disclosure.

### DETAILED DESCRIPTION

Alternative energy sources are increasing contributing to the overall power grid. In order to provide a constant and reliable source of energy, alternative sources such as wind turbines and solar panels experience output fluctuations due to environmental factors such as wind conditions and cloud cover. While these challenges may be addressed through load balancing and demand management, it is imperative that these systems are maintained and kept in good repair to ensure they operate at their full potential. With respect to wind turbines, other factors including environmental, political, geographical among other factors require that wind turbines frequently be placed in remote locations. For example, to avoid terrestrial conflicts and to leverage the increased wind speeds experiences over open water, wind turbines are often installed at offshore locations. However, because the wind turbines are installed in such remote locations, it is difficult and time consuming to provide a field technician to physically arrive at the turbine and perform maintenance, service or repairs. For this reason, embodiments described herein seek to increase the average time between required visits in remote equipment like wind turbines.

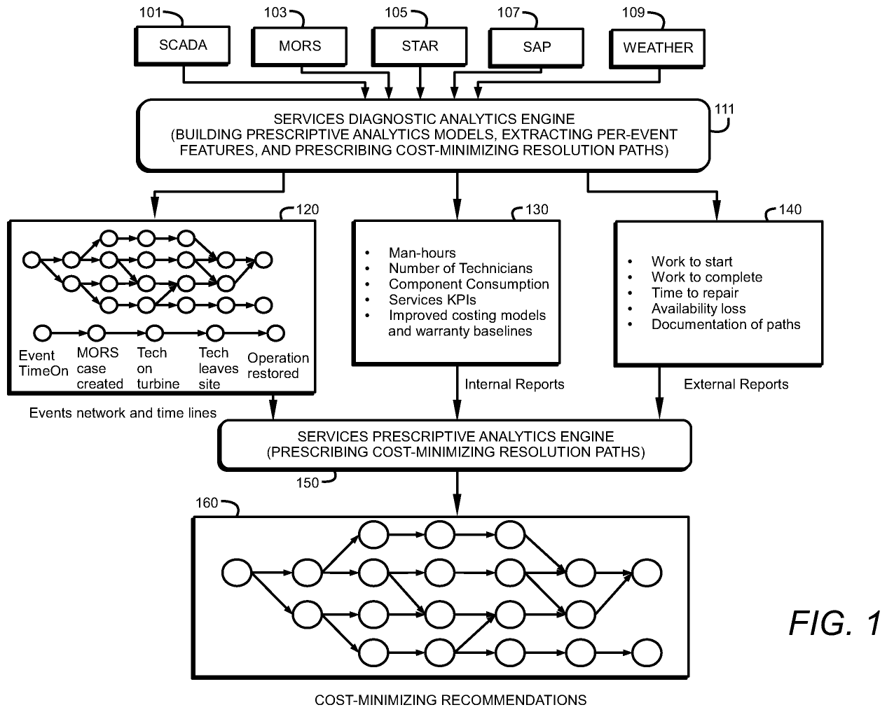

In embodiments described in this disclosure a new data-driven system and method is proposed. The method uses recorded events and sensor time series data. Referring to the architecture shown in FIG. 1, these data may come from various distributed sources, such as Supervisory and Data Acquisition (SCADA) 101, Monitoring, Operating and Registration System (MORS) 103, Service Tool for Analysis and Reimbursement (STAR) 105, Systems, Applications and Products (SAP) 107, and weather 109. The problem is configured as a pattern matching problem. The acquired data is provided to a specialized tool embodied in a services diagnostic analytics engine 111. The services diagnostic analytics engine 111 performs the tasks of building prescriptive analytics models, extracting per-event features and prescribing appropriate cost-minimizing resolution paths. The services diagnostic analytics engine 111 creates tools for optimizing service recommendations including neural networks analyzing events and times lines 120, internal reports 130, which may include information like man-hours expended, the number of technicians involved, components consumed, various key performance indicators (KPIs) and modeled cost improvements and baselines for warranty information.

External reports 140 may also be generated containing information such as date and time work is to begin, date and time the work will be complete, the amount of time the repair will take, the amount of time or percentage of time the equipment will be unavailable due to the repair, and paths indicating the actions required to affect the repair. The events network 120, internal reports 130 and external reports 140 are provided to a services prescriptive analytics engine 150 to generate problem resolutions focused on optimizing cost savings. The services prescriptive analytics engine 150 produces an optimized service recommendation 160 to performing the repair. The recommendation may be directly performed following the generation of the recommendation, or the recommendation may be provided to service personnel who have a final discretion on executing the recommendation. For example, upon detection of a fault that is identified with a tripped circuit breaker, the recommendation may be to remotely reset the breaker. Systems of embodiments described here may initiate a remote reset of the circuit breaker when the recommendation is generated. Alternatively, the recommendation may be provided to service personnel who may decide to attempt the remote reset of the circuit breaker, or may decide to take another course of action, such as reviewing proper operation of other related system components. The service personnel may override the recommendation and send a service technician onsite for the repair.

In some embodiments, the success of the attempted remote repair is monitored. For example, if the above referenced circuit breaker is remotely reset, but the fault events continue to occur, a recommendation may be updated to reflect that an in-person service call is warranted. When recurring faults like this occur, the analytics networks 111, 150 will archive the attempts and failures. These failed repair attempts and their ultimate resolutions will become part of the analytics data used to make future decisions. In this manner, the analytics engines 111, 150 learn over the lifetime of the components and systems. The system depicted in FIG. 1 provides two goals of the service recommendation process including, (1) finding unknown patterns in the data that lead to under-30-minute visits, and (2) matching alarm sequences to the identified patterns.

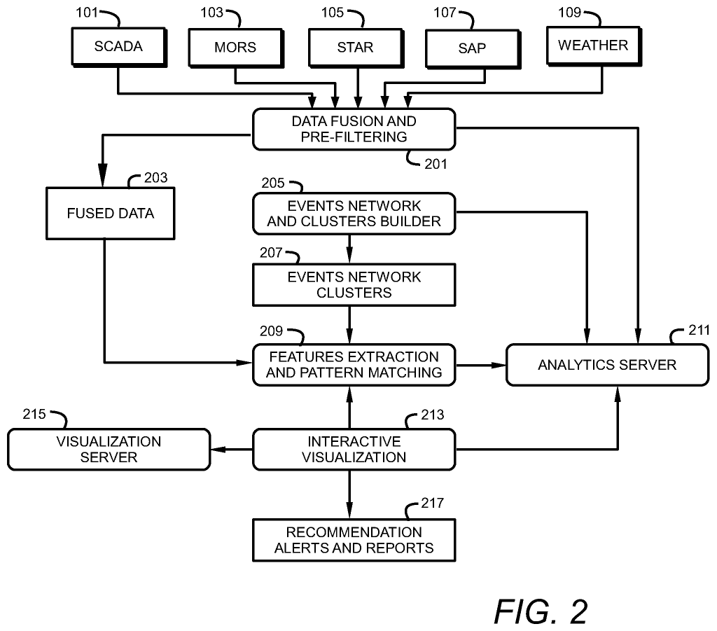

FIG. 2 is a schematic diagram of the system shown in FIG. 1 providing additional detail on the operation of the analytics engines. The data inputs may come from various distributed sources, such as Supervisory and Data Acquisition (SCADA) 101, Monitoring, Operating and Registration System (MORS) 103, Service Tool for Analysis and Reimbursement (STAR) 105, Systems, Applications and Products (SAP) 107, and weather 109. The data inputs are provided to the data fusion and pre-filtering 201 portion of the analytics tool. Here the data received from the multiple sources is combined and arranged so that the data in ingestible by the diagnostic analytics engine (FIG. 1, 111). The combined data is represented as fused data 203 and is further provided to the analytics server 211 for processing and retention. The fused data 203 provides information including information identifying events in the service cycle of the system. The events may be arranged in a neural network as depicted in FIG. 1 and events may be arranged in clusters to indicate when a sequence or group of events is identifiable with a service event or system fault. The events networks and clusters builder 205 provides the events network and clusters information to the analytics server 211 and produces events network clusters 207. The events clusters 207 and fused data 203 are inputs to the features extraction and pattern matching tool 209. The features extraction and pattern matching tool 209 analyzes the fused data 203 to identify features in the fused data 203 including a sequence of events that are identifiable as indicating a particular fault or as a predictor of an impending service based on past experience.

In addition, as new fused data 203 is acquired, the events sequences may be used along with the event networks clusters 207 to provide pattern matching of the newly acquired data to previously recognized event clusters. This information is provided to the analytics server 211 which performs additional processing and machine learning to produce optimized service action recommendations based on the inputs received including the fused data and event network clustering information among other inputs.

An interactive visualization 213 is provided with allows a user to interact with the analytics engines and the services recommendation tool in general. For example, the interactive visualization tool may provide information service recommendations generated in the analytics engines to a user for further decision-making, such as whether to execute the recommendation or take an alternative action. The user's inputs are provided to the analytics server 211 for additional training of the analytics engines. The user's actions become part of the input data for identifying certain event sequences and correlating those sequences to subsequent actions taken. Thus, the analytics engines learn when a given sequence of events leads to an associated action taken by a user. The analytics engines can then use that information in the future to make recommendation for similar actions if the given sequence of events is identified at some later time. The information provided to the interactive visualization tool 213 is provided to a visualization server 215 for storage and later retrieval. Information provided to the interactive visualization tool 213 may further be used to create recommendation alerts and reports 217.

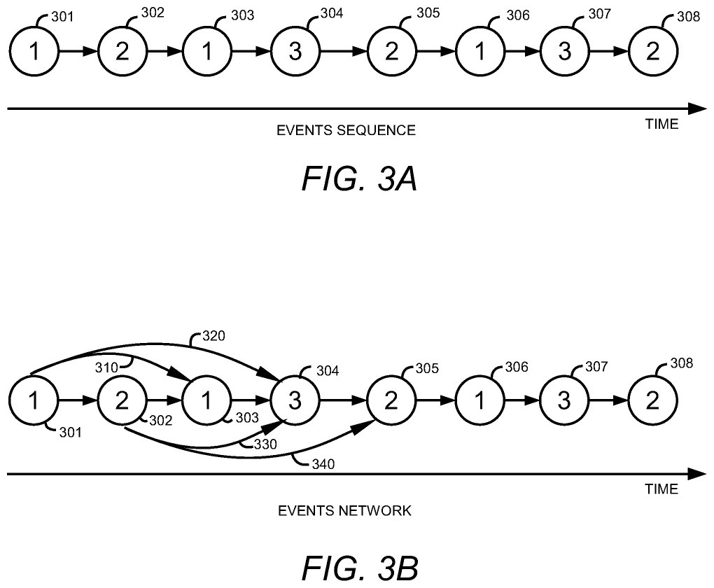

FIG. 3A and FIG. 3B illustrate the concept of an events network according aspects of embodiments of this disclosure. FIG. 3A show a chronological listing of events. The events are labeled as one of three specific events and an event type may recur during the timeframe being observed. For instance, event type 1 occurs three times in the timeframe at point 301, point 303 and point 306. Likewise, event type 2 occurs at point 302, point 305 and point 308. Finally, event type 3 occurs at point 304 and at point 307. The events occur sequentially in time. Information may be inferred based on the sequence of events. For example, if a temperature sensor detects a higher than normal temperature this may represent an increase in resistance in a power line. The increased resistance may create an increase in current through the line, which may cause a second event at a current sensor. An increase in current may cause a circuit breaker to trip, which would cause a third event. By analyzing the pattern of events, certain faults may be identifiable. However, some events may not be apparent when viewing the events chronologically. FIG. 3B illustrates the same sequence of events 301-308. In an events network, additional paths are defined that connect one event with a second event that may not directly follow the first event chronologically. That is, there may be one or more events that occur between the first event and the second event that are not related (e.g. they do not affect) the relationship between the first event and the second event. Referring to FIG. 3B, event type 1 at point 301 may recur at point 303 where event type 1 occurs a second time. The services diagnostic analytics engine (FIG. 1, 111) may make a connection 310 that represents the repeating of event type 1, while disregarding the intervening of event type 2 occurring at point 302. Likewise, a sequence of events where event type 1 at point 301 is followed, albeit not directly, by a type 3 event. A connection 320 may be made in the events network to connect these events. Other relationships may be identified as shown by path 330 connection event type 2 a point 302 with event type 3 at point 304 and the repeating of event type 2 at points 203 and 305 via relation 340.

The goals considered and achieved by the novel and innovative systems and methods described herein include:
Developing a data-driven tool for extracting patterns in events sequences indicative of short service visits.
Matching a given event sequence to the extracted patterns to determine the likelihood for a short service visit.
Auto-alerting registered service specialists.
Improving overall service performance by increasing the mean-time before visits while decreasing reaction time.

A concept of a newly-proposed score for ranking service elements over a given time period is now presented. Service records for a system were reviewed. Out of thousands of service visits A significant portion of the service calls exhibited a short duration (e.g. less than 30 minutes) as depicted in Table 1 below. A high percentage of these short-duration visits were resolved by locally resetting some devices. Since technology to reset the said devices remotely exists, remotely resetting devices would significantly reduce the number of visits. This in turn, potentially results in a lower-cost maintenance strategy. There exists a need for a tool that will predict, automatically or on-demand, potential short visits given a sequence of events. The tool may submit its recommendations to the remote diagnostics team for further evaluation and actions.

TABLE 1
Visits Distribution

| Duration | | Planned | Customer | |
|---|---|---|---|---|
| (minutes) | Maintenance | Repair | Visit | Other |
| [0, 15) | 24865 | 44352 | 9703 | 129184 |
| [15, 30) | 12667 | 19149 | 2895 | 53254 |
| [30, 45) | 10904 | 14906 | 2742 | 42197 |
| [45, 60) | 9927 | 12924 | 2497 | 37042 |
| [60, 75) | 9365 | 11661 | 1975 | 31913 |
| [75, 90) | 9117 | 10746 | 1746 | 28543 |
| [90, 105) | 8502 | 9889 | 1591 | 25840 |
| [105, 120) | 8237 | 9077 | 1391 | 23515 |
| [120, 135) | 8169 | 8259 | 1222 | 20739 |
| [135, 150) | 7968 | 7735 | 1111 | 18790 |
| [150, 165) | 7856 | 7086 | 1125 | 17233 |
| [165, 180) | 7776 | 6737 | 1004 | 15947 |
| [180, 195) | 7319 | 6231 | 890 | 14551 |
| [195, 210) | 6471 | 5591 | 815 | 13787 |
| [210, 225) | 5984 | 5147 | 719 | 12798 |
| [225, 240) | 5603 | 4651 | 686 | 11988 |

Based on this information, if events are identified that predict a short duration visit that can be resolved remotely, then many service visits requiring a physical visit to the site could be eliminated. Since service statistics do not include resolved incidents that do not require a physical visit, the result is a statistical analysis that indicates greater average times between services.

Nomenclature used in this disclosure for classifying types of service events will now be described. While the examples are described with respect to a service event on a wind turbine system, the described systems and methods may be used for other systems and service events as will be contemplated by those of skill in the art.

Type-1 Event—A type-1 service event is defined by one visit and the resolution of one work order. A type-1 service event timeline is thus defined by time stamps and durations from a system failure, (e.g. a turbine failure) until the turbine is back in operation.

Some key relevant time attributes of a type-1 events as follows:
Alarm on: time when the failure or fault was first detected.
Case created: time when the MORS case was created.
Visit started: time when the technician started preparing for the job.
Service started: time when the technician starts working on the turbine
Service stopped: time when the technician stops working on the turbine
Operation restored: time when the turbine is back in operation
Visit ended: time when the technician completed the visit

Type-2 event—A type-2 service event is defined by one visit and the resolution of at least two work orders.

Type-3 event—A type-3 service event is defined by at least two visits and the resolution of one work order.

Type-4 event—A type-4 service event is defined by at least two visits and the resolution of at least one work order.

In the embodiments described herein, service event sequences and their underlying faults and service actions are combined in a tool for generating recommendations for next actions. The combination of events, faults and actions provides a more complete context of service history.

In some embodiments, a novel performance score is devised that utilizes the concept of a positive column-stochastic matrix in combination with related fundamental linear algebra results to identify faults and associate an appropriate recommendation for corrective action. The generation of the performance score will now be described.

The generation of the performance score utilizes the concept of a positive column stochastic matrix. A matrix S is said to be positive if Sᵢⱼ>0 for all i and j. An n×n, L, matrix is said to be column-stochastic if all L's components are nonnegative and the sum of all components in each column of L is equal to one; that is,

[symbol]

ᵢⱼ>0,∀i,j, and Σᵢ [symbol] ᵢⱼ=1, for all j, respectively.

Based on the positive column-stochastic matrix, certain conditions are assumed to calculate the performance score Every column-stochastic matrix has 1 as an eigenvalue. Additionally, if S is positive and column-stochastic, then any eigenvector in V₁(S) has all positive or all negative components. Assume v and w to be linearly independent vectors in [symbol] ⁿ, n>2. Then, for some values of s and t that are not both zero, the vector s=sv+tw has both positive and negative components. Finally, if S is positive and column-stochastic then dim(V₁(S))=1.

Equipped with these fundamental linear algebra concepts, a positive column-stochastic matrix S is constructed based on the performance index concept. By way of example, given S, solve the linear algebraic system Sₓ=x subject to ∥x∥₁=1 to obtain the unique solution x*. Ordering the components of x* in decreasing order yields a unique ranking of components (e.g., turbines) in decreasing order of performance.

Given n wind turbines, n>1, and a time period [t₀, T], T>t₀, an n×n matrix S is defined, here called the performance score matrix as a convex combination of n×n link matrices, Lᵢ, i ∈{0,1,2}:

$${α}_{0} ∈ ( 0 , 1 ] , {α′}_{1} , {α}_{2} ∈ [ 0 , 1 ] , \\ {α}_{0} + {α}_{1} + {α}_{2} = 1 , \\ {ℓ}_{ij}^{0} = \frac{1}{n} , ∀ i , j$$

$${ℓ}_{ij}^{1} = \frac{𝔼 {\int }_{{t}_{0}}^{T} {u}_{ij} ( t ) dt}{{\sum }_{{i}^{′} = 1}^{n} 𝔼 {\int }_{{t}_{0}}^{T} {u}_{i ′ j} ( t ) dt} , ∀ i , j$$

$${ℓ}_{ij}^{2} = \frac{𝔼 {\int }_{{t}_{0}}^{T} {p}_{ij} ( t ) dt}{{\sum }_{{i}^{′} = 1}^{n} 𝔼 {\int }_{{t}_{0}}^{T} {p}_{i ′ j} ( t ) dt} , ∀ i , j$$

$$S = {α}_{0} {L}_{0} + {α}_{1} {L}_{1} + {α}_{2} {L}_{2} ,$$

where uᵢⱼ is a binary variable that is equal to 1 if there is a link from node i to node j, or 0 otherwise; pᵢⱼ denotes the performance index of l with respect to j. Here the convention that

$$\frac{0}{0} : = 0$$

is used.

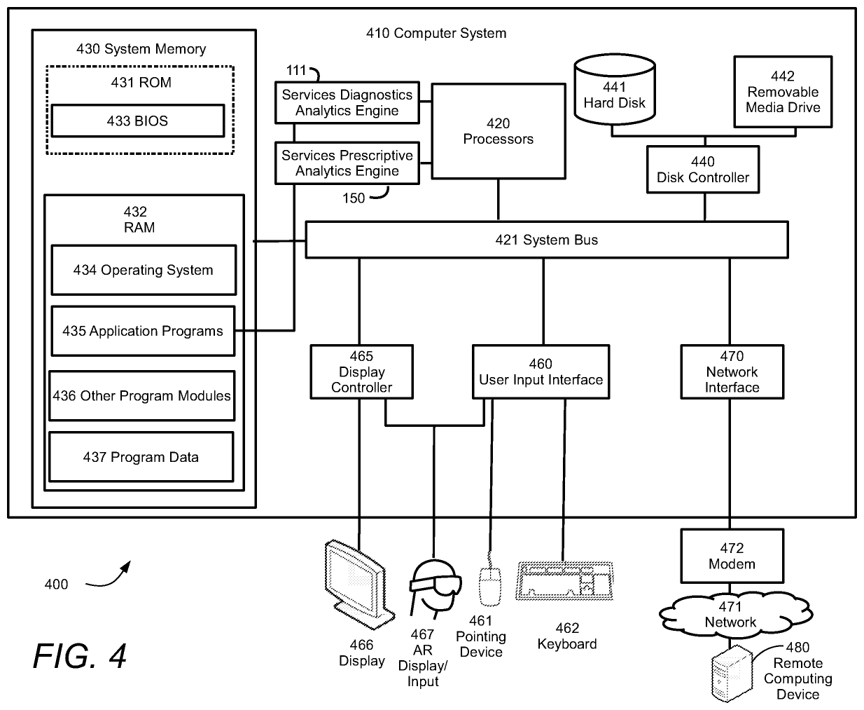

FIG. 4 illustrates an exemplary computing environment 400 within which embodiments of the invention may be implemented. Computers and computing environments, such as computer system 410 and computing environment 400, are known to those of skill in the art and thus are described briefly here.

As shown in FIG. 4, the computer system 410 may include a communication mechanism such as a system bus 421 or other communication mechanism for communicating information within the computer system 410. The computer system 410 further includes one or more processors 420 coupled with the system bus 421 for processing the information.

The processors 420 may include one or more central processing units (CPUs), graphical processing units (CPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 4, the computer system 410 also includes a system memory 430 coupled to the system bus 421 for storing information and instructions to be executed by processors 420. The system memory 430 may include computer readable storage media in the form of volatile and/or nonvolatile memory, such as read only memory (ROM) 431 and/or random-access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application programs 435, other program modules 436 and program data 437.

Special tools such as a services diagnostics analytic engine 111 and services prescriptive analytics engine 150 may be implemented from memory 432 as application programs 435 that execute on processor 420. These specialized tools operate to improve systems for maximizing mean time between service visits according to aspects of the embodiments described in this disclosure. These tools improve the functioning of the general-purpose computer to provide more efficient and robust analysis of system events and to provide recommendations for remedial actions, which improve the overall functioning and efficiencies of the systems.

The computer system 410 also includes a disk controller 440 coupled to the system bus 421 to control one or more storage devices for storing information and instructions, such as a magnetic hard disk 441 and a removable media drive 442 (e.g., floppy disk drive, compact disc drive, tape drive, and/or solid-state drive). Storage devices may be added to the computer system 410 using an appropriate device interface (e.g., a small computer system interface (SCSI), integrated device electronics (IDE), Universal Serial Bus (USB), or FireWire).

The computer system 410 may also include a display controller 465 coupled to the system bus 421 to control a display or monitor 466, such as a cathode ray tube (CRT) or liquid crystal display (LCD), for displaying information to a computer user. The computer system includes an input interface 460 and one or more input devices, such as a keyboard 462 and a pointing device 461, for interacting with a computer user and providing information to the processors 420. The pointing device 461, for example, may be a mouse, a light pen, a trackball, or a pointing stick for communicating direction information and command selections to the processors 420 and for controlling cursor movement on the display 466. The display 466 may provide a touch screen interface which allows input to supplement or replace the communication of direction information and command selections by the pointing device 461. In some embodiments, an augmented reality device 467 that is wearable by a user, may provide input/output functionality allowing a user to interact with both a physical and virtual world. The augmented reality device 467 is in communication with the display controller 465 and the user input interface 460 allowing a user to interact with virtual items generated in the augmented reality device 467 by the display controller 465. The user may also provide gestures that are detected by the augmented reality device 467 and transmitted to the user input interface 460 as input signals.

The computer system 410 may perform a portion or all the processing steps of embodiments of the invention in response to the processors 420 executing one or more sequences of one or more instructions contained in a memory, such as the system memory 430. Such instructions may be read into the system memory 430 from another computer readable medium, such as a magnetic hard disk 441 or a removable media drive 442. The magnetic hard disk 441 may contain one or more datastores and data files used by embodiments of the present invention. Datastore contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

The computing environment 400 may further include the computer system 410 operating in a networked environment using logical connections to one or more remote computers, such as remote computing device 480. Remote computing device 480 may be a personal computer (laptop or desktop), a mobile device, a server, a router, a network PC, a peer device or other common network node, and typically includes many or all the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 480). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof.

What is claimed is:

1. A method for increasing a mean time between service visits in an industrial system comprising:
receiving event information from at least one information source in communication with the industrial system;
building an event network from the received event information;
identifying a sequence of events indicative of a fault of the industrial system; and
determining a cost-minimized resolution to address the fault of the industrial system;
wherein the event network is configured to identify a sequence of events that do not occur in direct chronological sequence.

2. The method of claim 1, further comprising:
a services diagnostic engine configured to:
receive the event information;
extract features of each event in the event information;
identifying a relationship between a first event and a second event; and
creating a logical connection between the first event and the second event.

3. The method of claim 2, wherein the services diagnostics engine is further configured to:
generate at least one internal report based on the received event information.

4. The method of claim 2, wherein the at least one report includes at least one of:
a number of man hours required to perform a service embodied in the event information;
a number of service technicians required to perform a service embodied in the event information;
a number of components consumed in a service embodied in the event information; and
a key performance indicator relating to a service embodied in the event information.

5. The method of claim 2, wherein the services diagnostics engine is further configured to generate at least one external report based on the received event information.

6. The method of claim 5, wherein the at least one external report includes documentation of the logical connection between the first event and the second event.

7. The method of claim 1, further comprising:
a services prescriptive analytics engine configured to:
analyze an unidentified events sequence from the event network; and
associate the unidentified events sequence with a fault associated with a component of the industrial system.

8. The method of claim 7, further comprising:
generating a cost minimizing recommendation based on the fault associated with the unidentified events sequence.

9. The method of claim 7 further comprising:
training the services prescriptive analytics engine by annotating the unidentified events sequence with the fault associated with the unidentified events sequence.

10. The method of claim 7, wherein the cost minimizing recommendation includes a remote operation to reset a component of the industrial system.

11. The method of claim 10, wherein the remote operation is remotely resetting a circuit breaker.

12. The method of claim 10 wherein the cost minimizing recommendation is carried out automatically.

13. The method of claim 10 wherein the cost minimizing recommendation is presented to a user for consideration.

14. The method of claim 1, wherein the event information is selected from at least one of the following information sources:
a supervisory and data acquisition (SCADA) system;
a monitoring, operating and registration system (MORS);
a service tool for analysis and reimbursement (STAR);
systems, applications and products (SAP); and
weather data.

15. A system for increasing a mean time between service visits in an industrial system comprising:
a service diagnostics analytics engine configured to receive event information from at least one information source in communication with the industrial system and produce an events network identifying event sequences associated with a fault of the industrial system; and
a service prescriptive analytics engine configured to receive an events network from the service diagnostics analytics engine and perform a cost minimizing function to produce a cost minimizing recommendation to service a fault of the industrial system.

16. The system of claim 15 further comprising:
a communication channel in communication with a remote component of the industrial system and the service prescriptive analytics engine, the communication channel configured to transmit a signal operative to execute a remote reset of the remote component based on the cost minimizing recommendation of the service prescriptive analytics engine.

17. The system of claim 15 further comprising:
a user interface in communication with the service prescriptive analytics engine configured to present the cost minimizing recommendation to a user.

18. The system of claim 15, further comprising:
a remote controller for automatically performing an action based on the cost minimizing recommendation.

19. The system of claim 17, wherein the user interface further comprises:
a first control that allows a user to select automatic execution of the cost minimizing recommendation; and
a second control that allows the user to schedule an in-person service visit;
wherein one of the first control or the second control is selected based on the cost minimizing recommendation.

20. The system of claim 19, wherein the second control allows the user to select an action that is different than the cost minimizing recommendation.
